(19) United States
(12) Patent Application Publication
(10) Pub. No.: US 2015/0054805 A1
(43) Pub. Date: Feb. 26, 2015

(54) DISPLAY DEVICE

(71) Applicant: Samsung Display Co., Ltd., Yongin-City (KR)

(72) Inventors: JA EUN LEE, Gyeongsan-si (KR); SEUNGBAE LEE, Seoul (KR)

(73) Assignee: Samsung Display Co., Ltd., Yongin-City (KR)

(21) Appl. No.: 14/163,611

(22) Filed: Jan. 24, 2014

(30) Foreign Application Priority Data
Aug. 21, 2013 (KR) 10-2013-0099098

(51) Int. Cl. G09G 5/10

(52) U.S. Cl. CPC G09G 5/10
USPC 345/207

(57) ABSTRACT

A display device includes: an illumination detection unit which measures an external illumination value and outputs an illumination signal corresponding to the measured external illumination value; a control unit which determines an illumination range corresponding to the measured external illumination value based on the illumination signal and outputs a brightness control signal corresponding to the illumination range; and a display unit which displays an image based on the brightness control signal, where when the measured external illumination value corresponds to a low illumination range, an amount of brightness variation of the image displayed by the display unit is increased over time during a first interval.

This application claims priority to Korean Patent Application No. 10-2013-0099098, filed on Aug. 21, 2013, and all the benefits accruing therefrom under 35 U.S.C. §119, the content of which in its entirety is herein incorporated by reference.

### BACKGROUND

1. Field

The disclosure herein relates to a display device, and more particularly, to a display device that adjusts an initial brightness of an image by detecting surrounding illumination.

2. Description of the Related Art

A display device, such as a television, a navigation device and a computer monitor, includes a display panel that displays an image. The display device may be classified based on a type of the display panel therein. The display panel may include a plasma display panel, a liquid crystal display panel and organic light emitting display panel.

The display device including the display panel increases a brightness level in general to improve visibility. When a user turns on a display panel, if a brightness level of a first-viewed screen is too high, the user may be dazzled, and also if it is too low, the user may strain to view the dim image.

### SUMMARY

The disclosure provides a display device adjusting a change amount in initial brightness according to external illumination.

Embodiments of the invention provide a display device including: an illumination detection unit which measures an external illumination value and outputs an illumination signal corresponding to the measured external illumination value; a control unit which determines an illumination range corresponding to the measured external illumination value based on the illumination signal and outputs a brightness control signal corresponding to the illumination range; and a display unit which displays an image based on the brightness control signal, where when the measured external illumination value corresponds to a low illumination range, an amount of brightness variation of the image displayed by the display unit is increased over time during a first interval.

In some embodiments, the display devices may further include an input unit which outputs an input signal to the control unit based on an external input signal, where the control unit may output an operation signal to the illumination detection unit in response to the input signal; and the illumination detection unit may measure the external illumination value in response to the operation signal.

In other embodiments, when the measured external illumination value corresponds to the low illumination range, the image displayed by the display unit may have a predetermined brightness during a second interval after the first interval.

In still other embodiments, the predetermined brightness of an image displayed during the second interval may be substantially proportional to the measured external illumination value.

In even other embodiments, when the measured external illumination value corresponds to the low illumination range, the amount of brightness variation of the image displayed by the display unit may be decreased over time during a third interval after the first interval and before the third interval.

In yet other embodiments, the first interval may include a plurality of sub intervals, and the plurality of sub intervals may include: a first sub interval, during which a brightness of the image is maintained substantially constantly as a first brightness; a second sub interval, during which the brightness of the image is maintained substantially constantly as a second brightness, after the first sub interval; and a third sub interval, during which the brightness of the image is maintained substantially constantly as a third brightness, after the second sub interval, where a difference between the second brightness and the third brightness may be greater than a difference between the first brightness and the second brightness.

In other embodiments of the invention, a display devices includes: an illumination detection unit which measures an external illumination value and outputs an illumination signal corresponding to the measured external illumination value; a control unit determining which determines an illumination range corresponding to the measured external illumination value, and outputs a brightness control signal corresponding to the illumination range, where the illumination range includes a low illumination range, an intermediate illumination range and a high illumination range; and a display unit which displays an image based on the brightness control signal, where an amount of brightness variation of the image displayed by the display unit is increased over time during an initial interval when the measured external illumination value corresponds to the low illumination range.

In some embodiments, the display devices may further include an input unit which outputs an input signal to the control unit based on an external input signal, where the control unit may output an operation signal to the illumination detection unit in response to the input signal; and the illumination detection unit may measure the external illumination value in response to the operation signal.

In other embodiments, when the measured external illumination value corresponds to the low illumination range, the image displayed by the display unit may have a first convergence brightness during a stabilization interval after the initial interval.

In still other embodiments, the first convergence brightness may be substantially proportional to the measured external illumination value.

In even other embodiments, when the measured external illumination value corresponds to the low illumination range, the amount of brightness variation of the image displayed by the display unit may be decreased over time during an interval between the initial interval and the stabilization interval.

In yet other embodiments, when the measured external illumination value corresponds to the high illumination range, the image displayed by the display unit may have a peak brightness during an initial interval and have a second convergence brightness that is lower than the peak brightness during a stabilization interval after the initial interval.

In further embodiments, the second convergence brightness may be substantially proportional to the measured external illumination value.

In still further embodiments, the initial interval may include a plurality of sub intervals, and the plurality of sub intervals of the initial interval may include: a first interval during which a brightness of the image displayed by the display unit is increased to the peak brightness over time; and a second interval during which a brightness of the image displayed by the display unit is changed to the second convergence brightness from the peak brightness, over time.

In even further embodiments, the amount of brightness variation of the image displayed by the display unit may be increased over time during the second interval.

In yet further embodiments, the amount of brightness variation of the image displayed by the display unit may be decreased over time during the second interval.

In yet further embodiments, the second interval may include a plurality of sub intervals, and the plurality of sub intervals of the second interval may include: a first sub interval, during which the brightness of the image displayed by the display unit is maintained substantially constantly as a first brightness; a second sub interval, during which the brightness of the image displayed by the display unit is maintained substantially constantly as a second brightness, after the first sub interval; and a third sub interval, during which the brightness of the image displayed by the display unit is maintained substantially constantly as a third brightness, after the second sub interval, where a difference between the first brightness and the second brightness may be greater than a difference between the second brightness and the third brightness.

In yet further embodiments, when the measured external illumination value corresponds to the intermediate illumination range, the brightness of the image displayed by the display unit may be maintained substantially constantly as a third convergence brightness.

In yet further embodiments, the third convergence brightness may be substantially proportional to the measured external illumination value.

### BRIEF DESCRIPTION OF THE DRAWINGS

The above and other features of the invention will become more apparent by describing in further detail exemplary embodiments thereof with reference to the accompanying drawings, in which:

FIG. 1 is a block diagram showing an exemplary embodiment of a display device, according to the invention;

FIG. 2 is a flowchart illustrating an exemplary embodiment of a method of controlling an image brightness of a display device, according to the invention;

FIG. 3 is a flowchart illustrating an exemplary embodiment of an image brightness controlling method of a display device, according to the invention;

FIGS. 4A to 4C are graphs illustrating brightness versus time t of an image displayed by an exemplary embodiment of a display device, according to the invention;

FIGS. 5A to 5B are graphs illustrating brightness BR versus time t of an image displayed by an exemplary embodiment of a display device, according to the invention; and

FIG. 6 is a graph illustrating brightness BR versus time t of an image displayed by an exemplary embodiment of a display device, according to the invention.

### DETAILED DESCRIPTION OF THE EMBODIMENTS

The invention will be described more fully hereinafter with reference to the accompanying drawings, in which various embodiments are shown. The invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, exemplary embodiments of the invention will be described in detail with reference to the accompanying drawings.

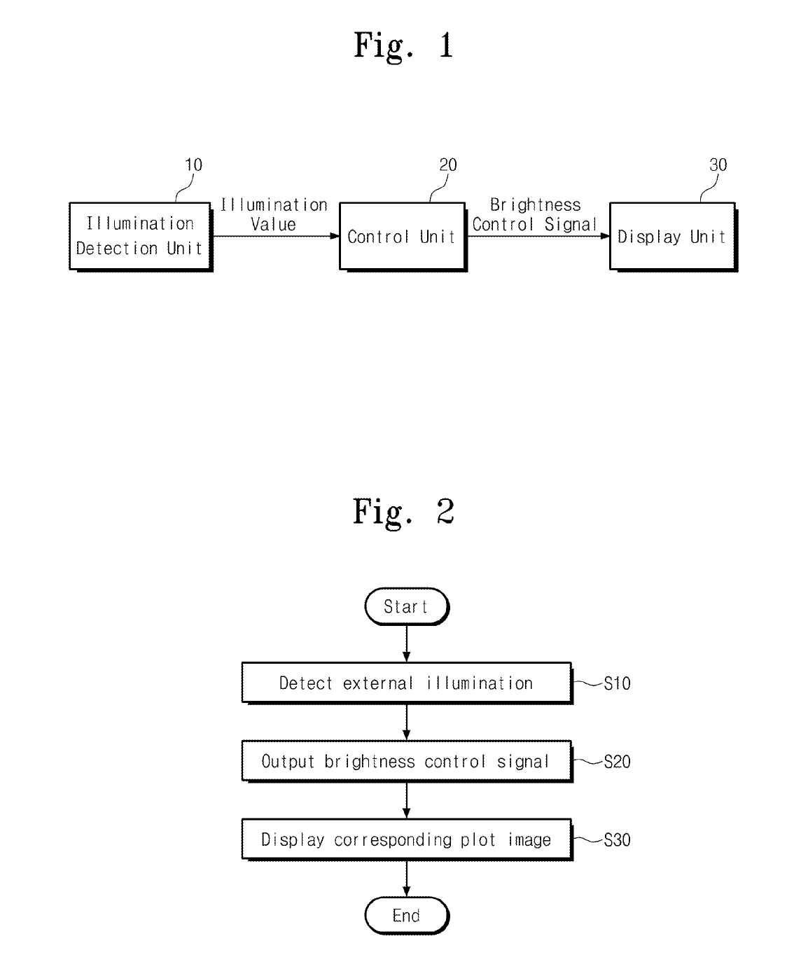

FIG. 1 is a block diagram of an exemplary embodiment of a display device, according to the invention. FIG. 2 is a flowchart illustrating an exemplary embodiment of a method of controlling an image brightness of a display device, according to the invention. Hereinafter, an operation of an exemplary embodiment of a display device will be described with reference to FIGS. 1 and 2.

In an exemplary embodiment, an on-signal may be applied to the display device from an external device (not shown). In an exemplary embodiment, an input unit (not shown) may generate the on-signal when detecting an external input signal, which will be described later in greater detail. The on-signal is delivered to an illumination detection unit 10 and controls, e.g., starts, an operation of the illumination detection unit 10.

When the illumination detection unit 10 operates, the illumination detection unit 10 detects external illumination (operation S10). The detecting of the external illumination (operation S10) is an operation for extracting a basic control factor to adjust the brightness of the image.

The illumination detection unit 10 detects the external illumination of the display device. The illumination detection unit 10 generates an illumination signal having an external illumination value, which is an illumination value corresponding to the external illumination. The illumination signal may be a digital signal or an analog signal. The illumination value becomes a reference factor for an initial brightness control of an image displayed on the display device. The illumination detection unit 10 transmits the outputted illumination signal to the control unit 20.

When the control unit 20 receives the illumination signal from the illumination detection unit 10, a brightness control signal is outputted (operation S20). In such an embodiment, the control unit 20 receives the illumination signal from the illumination detection unit 10 and generates the brightness control signal based on the illumination signal. The brightness control signal is a signal that adjusts the brightness of an image displayed by the display unit 30. The brightness control signal corresponds to the illumination value that the illumination signal indicates.

In an exemplary embodiment, the control unit 20 controls a general operation of the display. In one exemplary embodiment, for example, the control unit 20 may perform a control and processing relating to a voice call, data communication and a video call, for example. In such an embodiment, the control unit 20 may control an operation of the display unit 30, that is, the control unit 20 may adjust the brightness of an image displayed on the display unit 30 based on the illumination signal from the illumination detection unit 10.

The control unit 20 receives the illumination signal from the illumination detection unit 10 and determines an illumination range corresponding to the illumination value, e.g., an illumination range that the illumination value corresponds to. The illumination range may include a plurality of ranges corresponding to high and low measured illumination value. The brightness control signal is generated based on the illumination range. The control unit 20 transmits the brightness control signal to the display unit 30.

When the display unit 30 receives the brightness control signal, a corresponding plot image is displayed (operation S30). The display unit 30 generates an image using a signal received from the control unit 20, and displays the image on a screen thereof.

In an exemplary embodiment, the display unit 30 includes a display panel (not shown) for displaying an image. The display panel is not limited to a specific type of display panel, and may include an organic light emitting display panel, a liquid crystal display panel, a plasma display panel, an electrophoretic display panel or an electrowetting display panel.

The display unit 30 receives the brightness control signal from the control unit 20. The display unit 30 generates and displays an image corresponding to the brightness control signal. The image corresponding to the brightness control signal has different brightness plots corresponding to the illumination range. The display unit 30 may display an image, brightness of which is controlled based on external illumination.

In an exemplary embodiment, the display device may further include the input unit (not shown). The input unit includes an input device. The input unit receives an input signal from the input device and generates a signal for turning on/off the display device.

The illumination detection unit 10, the control unit 20 and the display unit 30 may operate based on an input signal outputted from the input unit as a turn-on signal. The input device is not limited to a specific type of input device, and may include a pressure reception device, a voice reception device, an electrical signal reception device, or heat detection device.

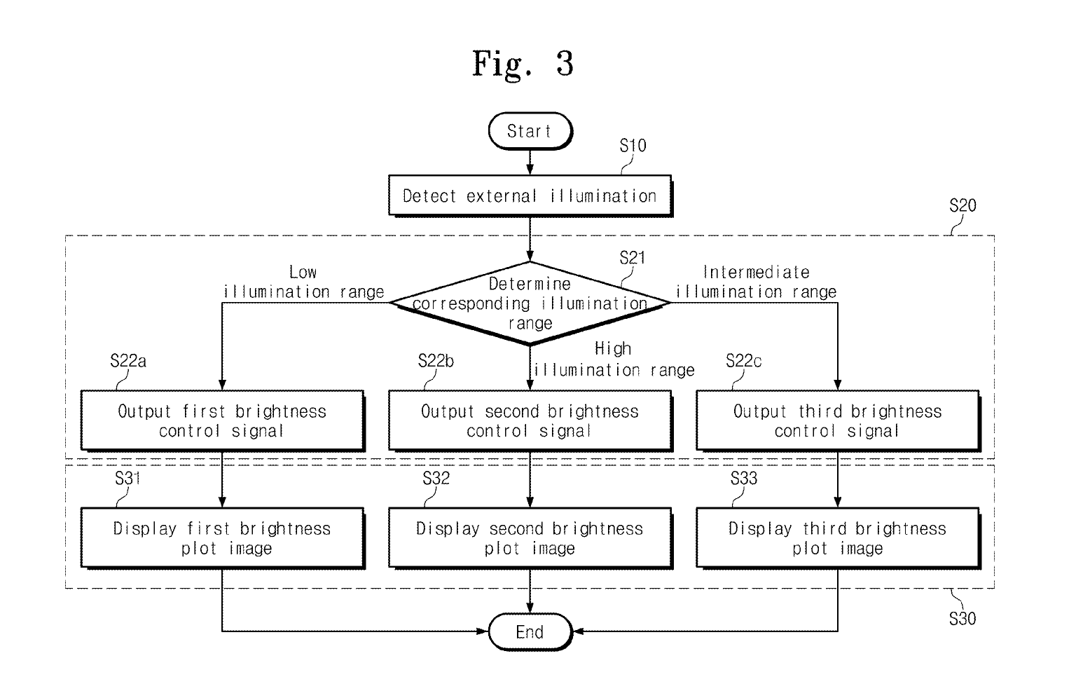

FIG. 3 is a flowchart illustrating an exemplary embodiment of an image brightness controlling method of a display device, according to the invention. Hereinafter, referring to FIG. 3, the outputting of the brightness control signal (operation S20) and the displaying of the corresponding plot image (operation S30) shown in FIG. 2 will be described in greater detail. The reference numerals used above to describe the method of controlling an image brightness of a display device shown in FIG. 2 refer to the same or like elements shown in FIG. 3, and any repetitive detailed description thereof will hereinafter be omitted.

In an exemplary embodiment, as shown in FIG. 3, the outputting of the brightness control signal (operation S20) may include determining an illumination range corresponding to external illumination (operation S21) and outputting corresponding brightness control signals (operations S22a, S22b, and S22c). The control unit 20 generates a brightness control signal corresponding to an illumination range corresponding to the illumination value.

During the determining of the corresponding illumination range (operation S21), the control unit 20 determines an illumination range corresponding to the measured illumination value. The illumination range may be divided into a plurality of ranges based on the high or low illumination value. In one exemplary embodiment, for example, the illumination range may be divided into a low illumination range and a high illumination range.

The low illumination range is the degree of brightness in which a user may feel uncomfortable for everyday activity. The low illumination range is an environment in which a user may feel dazzled when turning on a screen. In one exemplary embodiment, for example, the low illumination range may include an illumination value of about 10 luxes (lx) or less.

The high illumination range is the degree of brightness in which a user may feel bright. The high illumination range is an environment in which a user may not recognize an image on a screen properly. In one exemplary embodiment, for example, the high illumination range may include an illumination value of about 1000 lx or greater.

Furthermore, according to an exemplary embodiment of the invention, the control unit 20 may analyze the illumination value according to an illumination range further including an intermediate illumination range. The intermediate illumination range may include an illumination value greater than an illumination value in the low illumination range and less than an illumination value in the high illumination range.

The intermediate illumination range is an environment in which a user may not feel dazzled when turning on a screen or may not have a difficulty to view a screen. In one exemplary embodiment, for example, the intermediate illumination range may be from about 10 lx to about 1000 lx.

In an exemplary embodiment, the values of the illumination ranges may vary based on an external factor of the environment in which a display device is used, and thus are not limited to the above values. In an exemplary embodiment, the illumination ranges may be set variably based on the health and sensibility to visibility of a user using a display panel. Accordingly, the boundary of the illumination ranges may vary based on a usage environment of a display device. A user may freely or arbitrarily set the boundary of the illumination ranges corresponding to a display environment based on individual preferences.

In an exemplary embodiment, as shown in FIG. 3, the control unit 20 determines an illumination range corresponding to the measured illumination, and outputs a brightness control signal corresponding to the illumination range. In one exemplary embodiment, for example, if the measured illumination value corresponds to, e.g., belongs to or is within, a low illumination range, the control unit 20 performs the outputting of the first brightness control signal (operation S22a). If the measured illumination value corresponds to a high illumination range, the control unit 20 performs the outputting of the second brightness control signal (operation S22b).

In an exemplary embodiment, where the illumination range may further include the intermediate illumination range, if the measured illumination value corresponds to an intermediate illumination range, the control unit 20 outputs a third brightness control signal through the outputting of the third brightness control signal (operation S22c).

The display unit 30 generates a brightness-adjusted image in responses to the brightness control signal outputted from the control unit 20. Therefore, the display unit 30 outputs an image based on a brightness plot, initial brightness of which is differently controlled in response to the first to third brightness control signals.

As shown in FIG. 3, when the measured illumination value corresponds to a low illumination range, the display unit 30 performs displaying an image having a first brightness plot (operation S31). When the illumination value corresponds to the low illumination range, the control unit 20 generates a first brightness control signal. That is, the displaying of the image having the first brightness plot (operation S31) is performed in a dark illumination in which a user may feel dazzled when turning on a display device.

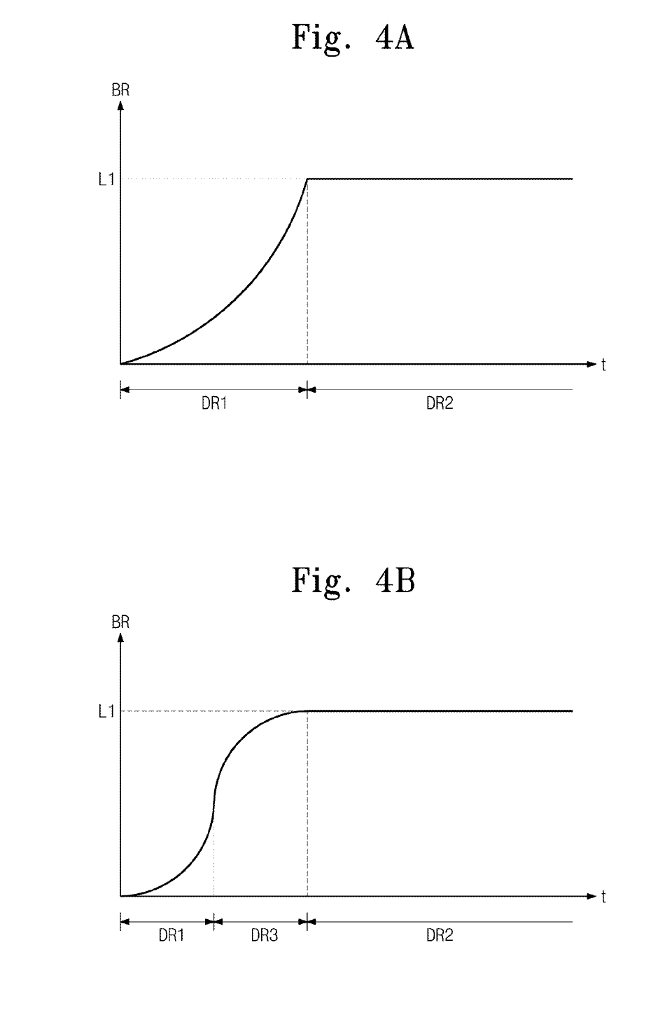

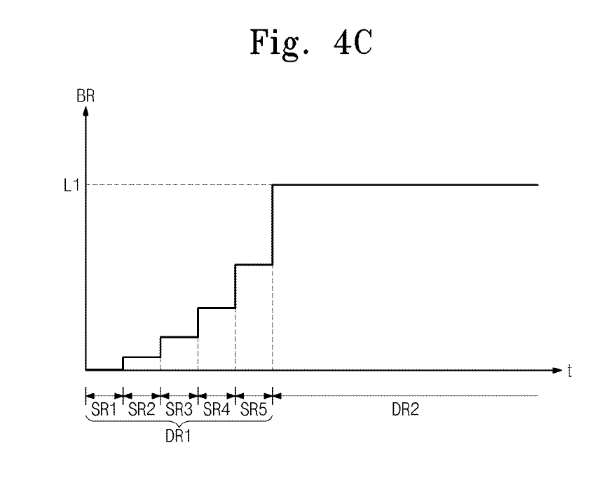

The display unit 30 displays an image having a first brightness plot by receiving the first brightness control signal, which will hereinafter be described in greater detail with reference to FIGS. 4A to 4C.

FIGS. 4A to 4C are graphs illustrating brightness BR versus time t of an image displayed by an exemplary embodiment of a display device, according to the invention. Exemplary embodiments of the first brightness plot is shown in FIGS. 4A to 4C. The first brightness plot includes an initial interval DR1, in which brightness changes over time when a turn-on signal is applied, and a stabilization interval DR2, in which a brightness becomes substantially uniform over time after the initial interval DR1.

The initial interval DR1 means an interval in which a screen starts to turn on when an on-signal is applied to the illumination detection unit 10. The stabilization interval DR2 means an interval in which the screen maintains a brightness determined by a user after the initial interval DR1. In the first brightness plot, a first interval may correspond to the initial interval DR1 and a second interval may correspond to the stabilization interval DR2. Additionally, hereinafter, a brightness may mean a value of brightness and thus may correspond to a brightness value.

Unlike the initial interval DR1, the stabilization interval DR2 maintains brightness to be substantially uniform. When the illumination value corresponds to a low illumination range, the display unit 30 displays an image having a first convergence brightness value L1 in the stabilization interval DR2. The first convergence brightness value L1 may be variously determined based on external illumination.

In one exemplary embodiment, for example, the first convergence brightness value L1 may be decreased or increased substantially proportional to the measured illumination value. Accordingly, the first convergence brightness value L1 may vary when an illumination value in the same illumination range is outputted. In such an embodiment, the first convergence brightness value L1 may be freely or arbitrarily set by a user for user's convenience independently of the external illumination.

As shown in FIG. 4A, the display unit 30 may generate an image in which an amount of brightness variation is increased in the initial interval DR1. When the measured illumination value corresponds to a low illumination range, the display unit 30 outputs an image of which change amount in initial brightness is increased over time. In one exemplary embodiment, for example, the display unit 30 may display an image having a brightness plot of an exponential function form in the initial interval DR1.

As a change amount in brightness is increased over time, the brightness of an image displayed on the display unit is gradually increased. The brightness of the image is gradually increased toward the first convergence brightness value L1. Since the change amount in brightness is increased over time, the image becomes brighter over time. Accordingly, as shown in FIG. 4A, the first convergence brightness value L1 may have a plot of a concave form overall in the initial interval DR1.

When the external illumination corresponds to a low illumination range, as turning on a screen, a user may feel dazzled due to abrupt exposure to bright light. At this point, an exemplary embodiment of a display device increases an initial brightness of the screen gradually, such that a predetermined time is provided for the optic nerve to adapt to light. Therefore, even under a dark environment of a low illumination range, a user may use the display device comfortably without hurting the eyes.

The degree of light sensitivity may vary according to the optic nerve of a user, and even in the same illumination range, a glare recognized by a user may vary due to external factors other than light. Accordingly, an exemplary embodiment of a display device controls a change amount in brightness in the initial interval DR1 to be increased gradually, such that a display device displays an image with brightness gradually changed for user's convenience.

In one exemplary embodiment, for example, as shown in FIG. 4B, the first brightness plot may further include a middle interval DR3 of a low illumination. The middle interval DR3 may be between the initial interval DR1 and the stabilization interval DR2. The display unit 30 may generate an image having brightness that is changed gradually in the middle interval DR3.

As shown in FIG. 4B, in the first brightness plot, a change amount in brightness is decreased gradually over time in the middle interval DR3. However, the invention is not limited thereto, and the brightness of the image may be variously changed in the middle interval DR3. In one exemplary embodiment, for example, the display unit 30 may generate an image having brightness, change amount of which is increased or decreased. In an alternative exemplary embodiment, the display unit 30 may generate an image having brightness that is substantially uniformly increased with a predetermined change amount. The brightness change in the middle interval DR3 may be set to have a plot that influences the user's optic nerve to a minimum.

In such an embodiment, the display unit 30 may display an image, brightness of which is changed discontinuously in the initial interval DR1. In one exemplary embodiment, for example, as shown in FIG. 4C, the display unit 30 may display an image having brightness that changes in a step form, in which an initial brightness is intermittently increased.

As shown in FIG. 4C, the display unit 30 may display an image having the initial interval DR1 including a plurality of sub intervals SR1, SR2, SR3, SR4 and SR5. The display unit 30 may display an image that maintains constant brightness values in the plurality of sub intervals SR1, SR2, SR3, SR4 and SR5.

The plurality of sub intervals may include a first sub interval SR1 in which the image is maintained as a first brightness, a second sub interval SR2 in which the image is maintained as a second brightness, a third sub interval SR3 in which the image is maintained as a third brightness, a fourth sub interval SR4 in which the image is maintained as a fourth brightness, and a fifth sub interval SR5 in which the image is maintained as a fifth brightness. The first to fifth sub intervals SR1, SR2, SR3, SR4 and SR5 are temporally sequentially arranged.

The first to fifth brightnesses have different brightness values. A difference between the second brightness and the first brightness is less than a difference between the third brightness and the second brightness. That is, the brightness difference between adjacent sub intervals tends to increase over time. Accordingly, the brightness of the image in the first interval shows a discontinuous plot in which a change amount increases over time.

In an exemplary embodiment, time periods of the initial interval DR1, the stabilization interval DR2 and the middle interval occupy may be different from each other. In such an embodiment, the initial interval DR1, the stabilization interval DR2 and the middle interval may be arbitrarily or freely set or changed by a user. Therefore, in such an embodiment, brightness of a screen of a display device is controlled based on a user's preference.

In an exemplary embodiment of a display device according to the invention, if the external illumination corresponds to a low illumination range, as the display device is turned on, a screen becomes brighter gradually. Accordingly, the display device may allow a user to view a screen comfortably in the dark without the initial glare.

Referring back to FIG. 3, the displaying of the image having the corresponding brightness plot (operation S30) may further include displaying a second plot image (operation S32). The displaying of the second plot image (operation S32) has a parallel relationship with the displaying of the first brightness plot image in operation S31, that is, one of the displaying of the second plot image (operation S32) and the displaying of the first brightness plot image in operation S31 is selectively performed.

When the measured illumination value corresponds to a high illumination range, the display unit 30 performs the displaying of the second plot image (operation S32). If the measured illumination value corresponds to the high illumination range, the control unit 20 generates a second brightness control signal. That is, the displaying of the second plot image (operation S32) is performed in a bright environment in which a user may not easily recognize information displayed on a screen due to a bright surrounding illumination as turning on the screen.

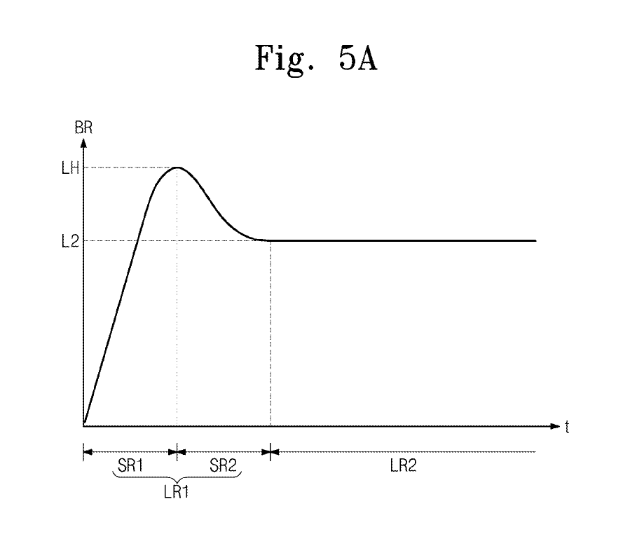

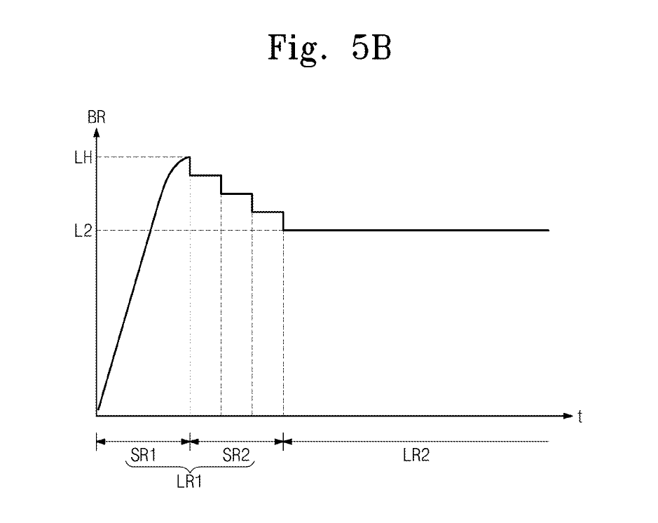

The display unit 30 outputs an image having a second brightness plot by receiving the second brightness control signal, which will be hereinafter described in greater detail with reference to FIGS. 5A and 5B.

FIGS. 5A to 5B are graphs illustrating brightness BR versus time t of an image displayed by an exemplary embodiment of a display device, according to the invention. Exemplary embodiments of the second brightness plot is shown in FIGS. 5A to 5B. As shown in FIGS. 5A and 5B, the second brightness plot includes an initial interval LR1 of high illumination, in which the peak plot occurs in initial brightness as a turn-on signal is applied, and a stabilization interval LR2 of high illumination, in which a brightness becomes uniform over time after the initial interval LR1.

Unlike the initial interval LR1, the stabilization interval LR2 maintains brightness to be substantially uniform. When the illumination value corresponds to a high illumination range, the display unit 30 display an image having a second convergence brightness L2 in the stabilization interval LR2. Time periods of the initial interval to the middle interval LR1, LR2 and LR3 may be different from each other, and may be arbitrarily set or changed by a user.

The second convergence brightness value L2 may vary according to the external illumination. In one exemplary embodiment, for example, the second convergence brightness value L2 may be increased or decreased substantially proportional to the measured illumination value. Therefore, even when an illumination value in the same illumination range is outputted, the second convergence brightness value L2 may vary. In such an embodiment, the second convergence brightness value L2 may be set arbitrarily by a user for user's preference independently of the external illumination.

As shown in FIGS. 5A and 5B, in the second brightness plot, a peak plot occurs in the initial interval LR1. The peak plot has a peak brightness value LH. The peak brightness value LH is greater than the second convergence value L2.

The peak plot allows an image displayed on the display unit 30 to become brighter steeply and to become darker gradually thereafter. The peak plot provides an instant bright image such that a user may easily view the image in the bright environment. The peak brightness value LH is not limited to a higher value than the second convergence brightness value L2. In one exemplary embodiment, for example, and the peak brightness value LH may have the same value as the measured illumination value or a higher value than the measured illumination value.

When the external illumination corresponds to a high illumination range and when a user turns on a screen, to the user may not immediately recognize a relatively dark screen, compared to the external illumination, due to adaptation of optical nerve of the user to bright light in the bright environment. Accordingly, in an exemplary embodiment, when the user turns on a screen, a display device sets the initial brightness of an image displayed on a screen to be high to correspond to the external illumination, and then, gradually reduces the brightness.

Through such a brightness control of an image, a time for the optical nerve of the user to adapt to a screen having a lower brightness compared to the external illumination may be provided. Accordingly, a user may use a display device comfortably in a bright environment in a high illumination range without difficulty in visibility.

In the same illumination range, the degree of darkness (visibility) that a user recognizes may vary by external factors other than light. Since degree of the sensibility to light varies according to the optical nerve of a user, the degree of illumination that a user feels dazzled or a time for adapting to a dark illumination may vary. Therefore, in an exemplary embodiment, when a display panel is turned on, a display device changes the brightness of the initial interval LR1 substantially gradually.

In one exemplary embodiment, for example, as shown in FIGS. 5A and 5B, the initial interval LR1 may include a plurality of sub intervals. The initial interval LR1 may include a first interval SR1 and a second interval SR2.

In the first interval SR1 the brightness of an image may gradually increases until it reaches the maximum brightness value LH. As shown in FIG. 5A, a change amount in the brightness of the image may be gradually decreased in the first interval SR1 However, the invention is not limited thereto. In an alternative exemplary embodiment, the brightness of the image may be increased linearly in the first interval SR1. In another alternative exemplary embodiment, the brightness of the image may be discontinuously changed in the first interval SR1.

The second interval SR2 is an interval in which brightness is gradually decreased from the maximum brightness value LH to the second convergence brightness value L2. A plot change in brightness of the image may have various forms in the second interval SR2.

In one exemplary embodiment, for example, as shown in FIG. 5A, the display unit 30 may generate an image in which change amount in brightness is gradually increased or decreased in the second interval SR2.

In an alternative exemplary embodiment, the display unit 30 may display an image in which brightness is discontinuously decreased in the second interval SR2. In one exemplary embodiment, for example, as shown in FIG. 5B, the second brightness plot may have a step-shaped plot in the second interval SR2.

As shown in FIG. 5B, the second interval SR2 may include a plurality of sub intervals. The display unit 30 may display an image in which each predetermined brightness value is maintained in the plurality of sub intervals.

The plurality of sub intervals maintains different brightnesses. In the second interval SR2, a brightness difference maintained in adjacent sub intervals may be different from each other. Accordingly, in an exemplary embodiment, the brightnesses maintained in the plurality of sub intervals may be reduced by a predetermined uniform difference. In an alternative exemplary embodiment, each brightness maintained in the sub interval may have a plot in which a change amount is decreased or increased from a brightness maintained in adjacent sub intervals.

Time periods of the initial interval LR1 and the stabilization interval LR2 may be different from each other. In one exemplary embodiment, for example, the initial interval LR1 may be substantially short to be recognized. In such an embodiment, a user may recognize an image having a peak brightness immediately after the display device is in an on-state. In an exemplary embodiment, the first interval SR1, the second interval SR2 and the plurality of sub intervals may have different time periods.

In an exemplary embodiment, a time period, a peak brightness, and convergence brightness values in each interval may be arbitrarily set or changed by a user. Therefore, a display device may control the brightness of a screen based on user's preference by setting the brightness of the screen to have a plot in which a brightness change may increase the user's visibility in the second interval SR2.

When the external illumination corresponds to a high illumination range, an exemplary embodiment of a display device may provide an image to allow a bright of the screen to become darker gradually when the display device is turned on. Therefore, the display device provides an environment in which a user in a bright surrounding may view a screen immediately after the screen is turned on without difficulty in initial visibility.

Referring back to FIG. 3, the displaying of the image having the corresponding brightness plot (operation S30) may further include displaying a third brightness plot image (operation S33). The displaying of the third brightness plot image (operation S33) has a parallel relationship with the displaying of the first brightness plot image (operation S31) and the displaying of the second brightness image (operation S32), that is, one of the displaying of the third brightness plot image (operation S33), the displaying of the first brightness plot image (operation S31) and the displaying of the second brightness image (operation S32) is selectively performed.

When the measured illumination value corresponds to the middle illumination range, the control unit 20 generates a third brightness control signal. Accordingly, an image having the third brightness plot is displayed in a bright environment in which a user may not feel dazzled as turning on a screen of a display device and may view a screen without difficulty in visibility.

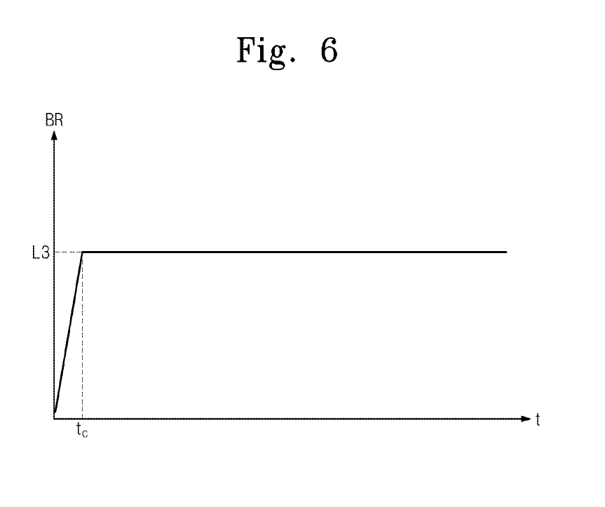

The display unit 30 displays an image having the third brightness plot by receiving the third brightness control signal, which will be hereinafter described in greater detail with reference to FIG. 6.

FIG. 6 is a graph illustrating brightness BR versus time t of an image displayed by an exemplary embodiment of a display device, according to the invention. An exemplary embodiment of the third brightness plot is shown in FIG. 6.

As shown in FIG. 6, the third brightness plot maintains a predetermined brightness value over time. When the measured illumination value corresponds to the middle illumination range, the display unit 30 displays an image having a brightness converged into the third convergence brightness value L3.

In the third brightness plot, there is a critical time t_{c} for reaching the third convergence brightness value L3. In an exemplary embodiment, the critical time t_{c} may vary based on an operating speed of a display device. Therefore, the critical time t_{c} may be too short for a user to recognize.

The third convergence brightness value L3 may vary based on an external illumination value. The third convergence brightness value L3 may be decreased or increased substantially proportional to the measured illumination value. Accordingly, even when an illumination value is in the same illumination range, the third convergence brightness value L3 may vary based on a specific value of the illumination value.

In an exemplary embodiment, the third convergence brightness value L3 may be arbitrarily set or change by a user. In such an embodiment, a display device may control a screen thereof to have comfortable visibility by adjusting the third convergence brightness value L3.

In an exemplary embodiment, the image brightness controlling method may further include determining whether the display device is in an illumination detection mode before the detecting of the external illumination (operation S10). In such an embodiment of a display device, a user may arbitrarily set whether to adjust brightness.

Accordingly, in an exemplary embodiment, the detecting of the external illumination in operation S10 may be set to be performed only when the illumination detection mode is turned on. When the illumination detection mode is turned off, the display unit 30 may display information immediately without performing the brightness controlling operation in a display device described above.

In an exemplary embodiment, a display device may include a comparison illumination control unit (not shown) that compares the measured illumination value with a predetermined brightness value of a screen and outputs the brightness control signal.

When the measured illumination value is less than the predetermined brightness value of a display device, the comparison illumination control unit outputs the first brightness control signal. Accordingly, the display unit 30 of FIG. 1 may generate an image in which a change amount in brightness is increased over time in the initial interval DR1 of low illumination shown in FIG. 4A.

In such an embodiment, when the measured illumination value is greater than the predetermined brightness value of a display device, the comparison illumination control unit outputs the second brightness control signal. Accordingly, the display unit 30 of FIG. 1 may generate an image having a peak brightness value in the initial interval LR1 of high illumination shown in FIG. 5A.

According to exemplary embodiments of the invention as described herein, the display device may provide an image having an initial brightness adjusted based on the external illumination. Therefore, a user may easily adapt to a screen and a user's visual fatigue is thereby substantially minimized.

The above-disclosed subject matter is to be considered illustrative and not restrictive, and the appended claims are intended to cover all such modifications, enhancements, and other embodiments, which fall within the true spirit and scope of the invention. Thus, to the maximum extent allowed by law, the scope of the invention is to be determined by the broadest permissible interpretation of the following claims and their equivalents, and shall not be restricted or limited by the foregoing detailed description.

What is claimed is:

1. A display device comprising:
an illumination detection unit which measures an external illumination value and outputs an illumination signal corresponding to the measured external illumination value;
a control unit which determines an illumination range corresponding to the measured external illumination value based on the illumination signal and outputs a brightness control signal corresponding to the illumination range; and
a display unit which displays an image based on the brightness control signal,
wherein when the measured external illumination value corresponds to a low illumination range, an amount of brightness variation of the image displayed by the display unit is increased over time during a first interval.

2. The display device of claim 1, further comprising:
an input unit which outputs an input signal to the control unit based on an external input signal,
wherein the control unit outputs an operation signal to the illumination detection unit in response to the input signal, and
wherein the illumination detection unit measures the external illumination value in response to the operation signal.

3. The display device of claim 2, wherein
when the measured external illumination value corresponds to the low illumination range, the image displayed by the display unit has a predetermined brightness during a second interval after the first interval.

4. The display device of claim 3, wherein
the predetermined brightness of the image displayed during the second interval is substantially proportional to the measured external illumination value.

5. The display device of claim 3, wherein
when the measured external illumination value corresponds to the low illumination range, the amount of brightness variation of the image displayed by the display unit is decreased over time during a third interval after the first interval and before the second interval.

6. The display device of claim 3, wherein
the first interval comprises a plurality of sub intervals; and
the plurality of sub intervals comprises:
a first sub interval, during which a brightness of the image is maintained substantially constantly as a first brightness;
a second sub interval, during which the brightness of the image is maintained substantially constantly as a second brightness, after the first sub interval; and
a third sub interval, during which the brightness of the image is maintained substantially constantly as a third brightness, after the second sub interval,
wherein a difference between the second brightness and the third brightness is greater than a difference between the first brightness and the second brightness.

7. A display device comprising:
an illumination detection unit which measures an external illumination value and outputs an illumination signal corresponding to the measured external illumination value;
a control unit which determines an illumination range corresponding to the measured external illumination value, and outputs a brightness control signal corresponding to the illumination range, wherein the illumination range comprises a low illumination range, an intermediate illumination range and a high illumination range; and
a display unit which displays an image based on the brightness control signal,
wherein an amount of brightness variation of the image displayed by the display unit is increased over time during an initial interval when the measured external illumination value corresponds to the low illumination range.

8. The display device of claim 7, further comprising:
an input unit which outputs an input signal to the control unit based on an external input signal,
wherein the control unit outputs an operation signal to the illumination detection unit in response to the input signal, and
wherein the illumination detection unit measures the external illumination value in response to the operation signal.

9. The display device of claim 8, wherein
the image displayed by the display unit has a first convergence brightness during a stabilization interval after the initial interval when the measured external illumination value corresponds to the low illumination range.

10. The display device of claim 9, wherein
the first convergence brightness is substantially proportional to the measured external illumination value.

11. The display device of claim 8, wherein
the amount of brightness variation of the image displayed by the display unit is decreased over time during an interval between the initial interval and the stabilization interval, when the measured external illumination value corresponds to the low illumination range.

12. The display device of claim 8, wherein
the image displayed by the display unit has a peak brightness during the initial interval and has a second convergence brightness lower than the peak brightness during a stabilization interval after the initial interval, when the measured external illumination value corresponds to the high illumination range.

13. The display device of claim 12, wherein
the second convergence brightness is substantially proportional to the measured external illumination value.

14. The display device of claim 12, wherein
the initial interval comprises a plurality of sub intervals, and
the plurality of sub intervals of the initial interval comprises:
a first interval during which a brightness of the image displayed by the display unit is increased to the peak brightness over time; and
a second interval during which the brightness of the image displayed by the display unit is changed to the second convergence brightness from the peak brightness over time.

15. The display device of claim 14, wherein
the amount of brightness variation of the image displayed by the display unit is increased over time during the second interval.

16. The display device of claim 14, wherein
the amount of brightness variation of the image displayed by the display unit is decreased over time during the second interval.

17. The display device of claim 14, wherein
the second interval comprises a plurality of sub intervals; and
the plurality of sub intervals of the second interval comprises:
a first sub interval, during which the brightness of the image displayed by the display unit is maintained substantially constantly as a first brightness;
a second sub interval, during which the brightness of the image displayed by the display unit is maintained substantially constantly as a second brightness, after the first sub interval; and
a third sub interval, during which the brightness of the image displayed by the display unit is maintained substantially constantly as a third brightness, after the second sub interval,
wherein a difference between the first brightness and the second brightness is greater than a difference between the second brightness and the third brightness.

18. The display device of claim 17, wherein
the brightness of the image displayed by the display unit is maintained substantially constantly as a third convergence brightness when the measured external illumination value corresponds to the intermediate illumination range.

19. The display device of claim 18, wherein the third convergence brightness is substantially proportional to the measured external illumination value.
